(19) United States
(12) Patent Application Publication
(10) Pub. No.: US 2008/0227078 A1
(43) Pub. Date: Sep. 18, 2008

(54) Weighted rating process for rating a changing, subjective category

(76) Inventor: Cristian Andrew Miller, Los Angeles, CA (US)

Correspondence Address: Cristian Miller, 8038 Blackburn Ave #1, Los Angelels, CA, 90048, US

(21) Appl. No.: 11/687,327

(22) Filed: Mar. 16, 2007

(51) Int. Cl. G09B 7/00

(52) U.S. Cl. 434/322

(57) ABSTRACT

An invention used to solve the problem in rating a changing, subjective category, like a person's subjective evaluation of their experiences dating someone, tempered by the changing state of their emotions as they deal with the breakup.

For decades financial credit history companies have been applying a rating system to the behavior of people for the purpose of minimizing risk. And with the rise of Ebay.com, online retailers have adopted the process. Both processes are based on the idea that the reporting (or reviewing) agents are all equal in weight.

Financial Credit History companies determine their score by putting the objective data supplied to them into a formula and than comparing it to the population that the person lives within. The objective nature of the information that financial credit history companies use is what makes this invention novel. The objective criteria that Financial Credit History companies use are:
punctuality of payment in the past (only includes payments later than 30 days past due)
the amount of debt, expressed as the ratio of current revolving debt (credit card balances, etc.) to total available revolving credit (credit limits)
length of credit history
types of credit used (installment, revolving, consumer finance)
recent search for credit and/or amount of credit obtained recently

When using objective data to calculate risk, the variations in the sources of the report become negligible. And since credit scores are used to quantify a person's single behavior (their likelihood to pay back debt), the isolation of that single behavior allows the financial credit history companies to ignore the differences between the various types of reporting (or reviewing) agents i.e. since the focus is an individual's pattern of debt repayment, the individual's history of paying their mortgage to bank ‘A’, is equal to their history of paying their car loan to bank ‘B’.

In short, financial credit history companies use objective data to calculate a single behavior and this allows them to ignore the differences between reporting agents.

In comparison to a credit history companies, the reviewing systems used by online retailers like ebay.com are primitive. Currently, online retailers create scores by asking reviewing agents to quantify their subjective experience with the product or website, and then giving each review an equal weight when compared to each other. This function is considered a valuable add-on to a website's functionality even though the experiences of a customer that has a product shipped 2000 miles might vary greatly from the experiences of a customer that lives in the same city of the company.

Currently the only networking websites that employ rating systems are dating websites and they use systems similar to online retailers. The dating websites that do use rating systems: create their scores by asking reviewers to quantify their subjective experiences with the subject, and then give the reviews equal weight in their calculation of the score.

To use a rating system in this way is rudimentary, and the flaws become even more glaring when the system is applied to the highly subject world of dating. The systems currently employed by dating sites don't adjust their scores for the truthfulness or temperament of the reviewer, or their emotional state when writing the review. That means that at best the scores offered by the dating sites are “non-reflective” of a subject's actual character, making the scores useless to the reader and disappointing to the subject.

### AN EXAMPLE OF THE APPLICATION OF THE ‘WEIGHTED RATING PROCESS FOR RATING A CHANGING, SUBJECTIVE CATEGORY’ USING A DATE NETWORKING WEBSITE (RateABull.com)

### Verification Points (Reviewer's Personal Information Quantification)

Verification points is the weight by which a reviewer's input will effect the subject's score. A person's verification points represent the ability of RateABull.com to verify that the reviewer is who they claim to be.

A person can get 1 through 5 verification bulls for their profile. A person will get 1 bull for responding to the confirmation email that they are sent after signing up for membership. A person gets 2 bulls for responding to the confirmation email sent to their MySpace, or other social networking website that they listed as being theirs.

They get 3 bulls after they have gotten at least 4 testimonials or 2 date review. They get 4 bulls if they purchase an item from the design store using a world pay or pay pal account. They will get 5 bulls if they purchase an item from RateABull using a credit card.

### Date Reviews (The Subjective Category)

A person can earn or lose a maximum of 400 points through the date reviews. Each date can give a maximum of 133 points.

The dates will give them a score of −5 through 5 (zero is not a choice) −5 indicates a very bad dater. 5 indicates a perfect dater. That score is turned into either a negative or positive percentage and is multiplied by 133 points. The result is then multiplied by their verification score.

So for example if a date gives the user a score of 4 (a positive 80%) and they have a verification score of 3 out of 5 bulls, then it would be 133*80%=106.4. Then 106.4 is multiplied by their verification score which is 106.4*60%=63.84. So that positive date review will increase the other person's score by 63.84 points (the dating score will only be a whole number so round off the points). If the review was a minus 4 then the person would lose 63.84 points.

### Date Review Questions

1. C Did they act like they wanted to be there? Yes=1
2. C Did they offer to pay for your meal? Yes=1
3. C Did they make you laugh enough? Yes=1
4. C Did you do things that you wanted to do together at least half of the time? Yes=1
5. C Did you feel that they listened to you when you spoke? Yes=1
6. R Did you have sex?
7. R Were they a good kisser? Yes=1
8. R Did the date seem like them made an effort to make your date a special night? Yes=1
9. R Did they make an effort to ensure that you were satisfied? Yes=1; No=−4
10. R Describe your sexual experience together on a scale from boring to a great time. 4 or 5 out of 5=1
11. R. Did you often get mixed or confusing signals from your date? No=1
12. T Did they cheat on you? No=1; Yes=−4
13. T Did you feel that you could trust them? Yes=1
14. T Did they give you reason to not trust them? No=1
15. T Did they promise to call and then not, or did they not call you back when they said that they would? No=1
16. T Did the break up come as a complete surprise to you or did you know it was ending? No=1
17. T Did you feel used by your date? No=1
18. T Did you feel like you were lied to during your date? No=1
19. How long did you date?
19a. How long ago did you stop dating?
20. Did you date exclusively?
21. Would you recommend them to someone else? Yes=2
22. Would you describe yourself as picky? Yes=1
23. Did they break up with you?
24. What could they have done to be a better date?
25. What do you want other people to know about him or her?
26. Describe how your relationship ended?
27. What would you describe their most positive strength? Humor, responsibility, loyalty, Caregiver, independence.
28. Give this person a score as a dater −5 (no one should ever go out with this guy) through 5 (go out with them, if you have the chance), there is no zero.

### Romance, Trust/Reliability, Companionship

This date review survey will total up to a maximum of 20 points (question 28 is not included). The score out of 20 will be divided by 4 and then added to the score given in 28 (if it is a positive number) and then divided by 2. If question 28 is a negative number then the 1 through 20 score is ignored.

So for example, if a person rates their dating experience as a 16 out of 20, and gives them a score of 2 on question 28, then 16 will be divided by 4 giving the score of 4. 4 will then be added to 2 giving them a total of 6 and then the 6 will be divided by 2 to give an average of 3. 3 is then used as score that is used in the ‘Date Review’ section above.

### Freshness of Break-up Weight (The Changing Category)

Taking into account that the rule of thumb is “if a relationship lasts longer than 3 months, it takes about one quarter of the time that you're with someone to stop feeling the pain associated with a break-up,” then the emotionality that a person feels during a fresh break-up must be taken into account.

The length of time in question 19a should be divided by the length of time in question 19. If the relationship lasted longer than 3 months, and the result of the calculation between question 19 and 19a is 25% or less, and the reviewer's review is negative, than the subject will only lose 66% of the points that they would have lost if the ‘Freshness of Break-up Weight’ was not applied.

If a review was written within this 25% break-up period, then one month after the end of the 25% break up period, an email will be sent out and the reviewer will be allowed to reassess their review. The weight generated during this reassessment would be permanent.

So for example, if a subject were to lose 63.84 points because of someone's negative date review, but the review was written 1 month after the break-up of a year long relationship, then the subject will lose 63.84*0.66 which is 42.13 points. And if after the reviewer receives the reassessment email they reexamine their answers and feel that their original answers still apply, then the subject will then get back whatever points they initially lost because of the bad review and they will then lose 63.84 points from their score.

### Giving Too Many Negative Reviews (Dynamic Chances)

If more than 50% of a person's date reviews are negative and a person gives more than 2 negative reviews it initiates a system that affects the reviewer's score in a negative way while affecting their past reviews in a positive way.

After a reviewer has given their 3^{rd} negative review, the reviewer loses 5% of their total score. The reviewer's bad rating is applied to the person that they are reviewing, but afterwards 5% of the points of everyone that person has reviewed negatively is given back.

So, for example a reviewer has a score of 650 before his 3^{rd} bad review. They have a verification score of 3 out of 4 bulls and they give someone a date review of −4. The person that the reviewer has given the −4 to losses 63.84 points. Then the reviewer himself losses 5% of 650 giving him a new score of 617.5. Then everyone that the reviewer has reviewed negatively gets back 5% of points that they lost because of the reviewer's bad reviews. So this latest bad review would then get back 3.192 points.

If the reviewer immediately gives a 4^{th} bad review then they will then lose a total of 10% of their score (it would be taken off of the score they would have if no negative reviews were applied). And everyone they have reviewed would then get back 10% of the original points that they lost as a result of the bad review.

So in this example, after our reviewer used in the example above has given their 4^{th} review, the reviewer's score drops to 585 points. That is because 1.0% is taken off of the score they would have had if they never gave a bad review. In this case that clean score would again be 650. So when 10% is taken off of 650 their score drops to 585 points.

I will use the person who got the 3^{rd} review in the example to show how everyone who got a bad review is affected by the reviewer giving a 4^{th} negative review The person who got the 3^{rd} negative review originally lost 63.84 points. They now get 10% of the points back. That means that they now get back 6.384 points of the 63.84 points lost.

The scale is as follows:

| | | Reviewer's Score | Person Reviewed Negatively |
|---|---|---|---|
| Negative review # | 3 | −5% | +5% |
| | 4 | −10% | +10% |
| | 5 | −20% | +15% |
| | 6 | −30% | +20% |
| | 7 | −40% | +40% |
| | 8 | −50% | +60% |
| | 9 | −60% | +80% |
| | 10 | −70% | +100% |
| | 11 | −80% | |
| | 12 | −90% | |
| | 13 | −100% | |

After they have written their 10^{th} negative review, a warning should appear on their profile that says, “Warning, if you go out with this person, they will most likely write something bad about you.”

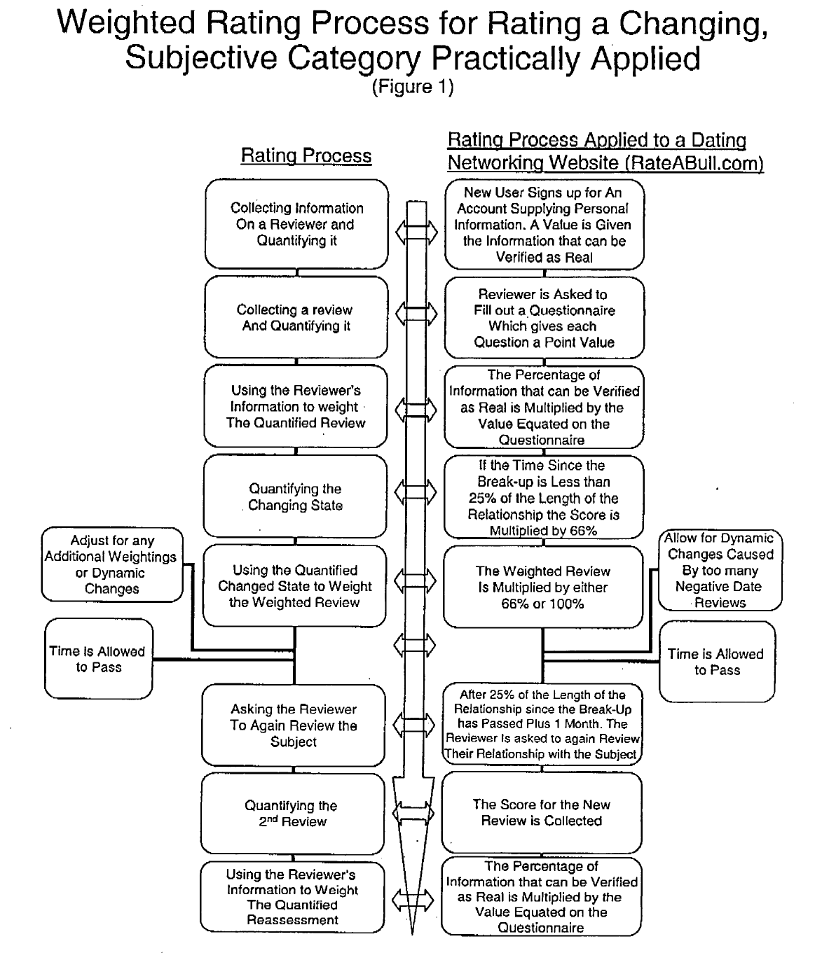

### FIG. 1

FIG. 1 is the Weighted Rating Process for Rating a Changing, Subjective Category practically applied to a date rating system.

What is claimed is:

1. A ‘Weighted Rating Process for Rating a Changing, Subjective Category’—is a process by which a subjective, changing category can be rated. The process is a follows:
1. Collecting information on a reviewer and quantifying it
2. Collecting a review and quantifying it
3. Using the reviewer's information to weight the quantified review
4. Quantifying the changing state
5. Using the quantified changing state to weight the “review that has been weighted by the reviewer's information”
6. Adjust for any additional weightings or dynamic changes
7. Waiting a time period
8. Asking the reviewer to again review the subject
9. Quantifying the 2^{nd} review
10. Using the reviewer's information to weight the quantified reassessment
The result is a score that is based on reviews, but takes into account the specifics of the reviewer, their truthfulness and how their attitude might change over time.
